(19) United States
(12) Patent Application Publication
(10) Pub. No.: US 2023/0026867 A1
(43) Pub. Date: Jan. 26, 2023

(54) METHOD FOR WIRELESS X2X ACCESS AND RECEIVERS FOR LARGE MULTIDIMENSIONAL WIRELESS SYSTEMS

(71) Applicant: Continental Teves AG & Co. OHG, Frankfurt am Main (DE)

(72) Inventors: David Gonzalez Gonzalez, Egelsbach (DE); Andreas Andrae, Frankfurt am Main (DE); Osvaldo Gonsa, Frankfurt am Main (DE); Hiroki Iimori, Yokahama (JP); Giuseppe Thadeu Freitas de Abreu, Bremen (DE); Razvan-Andrei Stoica, Essen (DE)

(21) Appl. No.: 17/778,703

(22) PCT Filed: Nov. 20, 2020
(86) PCT No.: PCT/EP2020/082987

§ 371 Date: May 20, 2022

(30) Foreign Application Priority Data
Nov. 22, 2019 (DE) 10 2019 218 089.2

(51) Int. Cl. H04W 28/02; H04B 7/0456; H04L 25/03

(52) U.S. Cl. CPC H04W 28/0284; H04B 7/0456; H04L 25/03197

(57) ABSTRACT

Estimating transmit symbol vectors transmitted in an overloaded communication channel includes receiving a signal represented by a received signal vector, the received signal vector corresponding to a superposition of signals representing transmitted symbols selected from a constellation of symbols and transmitted from one or more transmitters.

### FIELD OF INVENTION

The present invention relates to the field of digital communications in overloaded channels.

### BACKGROUND

It is estimated that by 2030, over 100 billion wireless devices will be interconnected through emerging networks and paradigms such as the Internet of Things (IoT), fifth generation (5G) cellular radio, and its successors. This future panorama implies a remarkable increase in device density, with a consequent surge in competition for resources. Therefore, unlike the preceding third generation (3G) and fourth generation (4G) systems, in which spreading code overloading and carrier aggregation (CA) were add-on features aiming at moderately increasing user or channel capacity, future wireless systems will be characterized by nonorthogonal access with significant resource overloading.

The expressions “resource overloading” or “overloaded communication channel” typically refers to a communication channel that is concurrently used by a number of users, or transmitters, T, whose number NT is larger than the number NR of resources R. At a receiver the multiplicity of transmitted signals will appear as one superimposed signal. The channel may also be overloaded by a single transmitter that transmits a superposition of symbols and thereby goes beyond the available channel resources in a “traditional” orthogonal transmission scheme. The “overloading” thus occurs in comparison to schemes, in which a single transmitter has exclusive access to the channel, e.g., during a time slot or the like, as found in orthogonal transmission schemes. Overloaded channels may be found, e.g., in wireless communication systems using Non-Orthogonal Multiple Access (NOMA) and underdetermined Multiple-Input Multiple-Output (MIMO) channels.

One of the main challenges of such overloaded systems is detection at the receiver, since the bit error rate (BER) performances of well-known linear detection methods, such as zero-forcing (ZF) and minimum mean square error (MMSE), are far below that of maximum likelihood (ML) detection, which is a preferred choice for detecting signals in overloaded communication channels. ML detection methods determine the Euclidian distances, for each transmitter, between the received signal vector and signal vectors corresponding to each of the symbols from a predetermined set of symbols that might have been transmitted, and thus allow for estimating transmitted symbols under such challenging conditions. The symbol whose vector has the smallest distance to the received signal's vector is selected as estimated transmitted symbol. It is obvious, however, that ML detection does not scale very well with larger sets of symbols and larger numbers of transmitters, since the number of calculations that need to be performed for large sets in a discrete domain increases exponentially.

The Prior-Art related to this invention comprises both scientific papers and patents.

In order to circumvent this issue, several signal detection methods based on sphere decoding have been proposed in the past, e.g. by C. Qian, J. Wu, Y. R. Zheng, and Z. Wang in “Two-stage list sphere decoding for under-determined multiple-input multiple-output systems,” IEEE Transactions on Wireless Communication, vol. 12, no. 12, pp. 6476-6487, 2013 and by R. Hayakawa, K. Hayashi, and M. Kaneko in “An overloaded MIMO signal detection scheme with slab decoding and lattice reduction,” Proceedings APCC, Kyoto, Japan, October 2015, pp. 1-5, which illustrate its capability of asymptotically reaching the performance of ML detection at lower complexity. However, the complexity of the known methods grows exponentially with the size of transmit signal dimensions, i.e., the number of users, thus preventing application to large-scale systems.

R. Hayakawa and K. Hayashi, in “Convex optimization-based signal detection for massive overloaded MIMO systems,” IEEE Transactions on Wireless Communication, vol. 16, no. 11, pp. 7080-7091, November 2017, propose a low-complexity signal detector for large overloaded MIMO systems for addressing the scalability issue found in the previous solutions. This low complexity signal detector is referred to as sum-of-absolute-value (SOAV) receiver, which relies on a combination of two different approaches: a) the regularization-based method proposed by A. Aïssa-El-Bey, D. Pastor, S. M. A. Sbaï, and Y. Fadlallah in “Sparsity-based recovery of finite alphabet solutions of underdetermined linear system,” IEEE Transactions on Information Theory, vol. 61, no. 4, pp. 2008-2018, 2015, and b) the proximal splitting method described by P. L. Combettes and J.-C. Pesquet in “Proximal splitting methods in signal processing,” Fixed-point algorithms for inverse problems in science and engineering, pp. 185-212, 2011. This means the scope of R. Hayakawa and K. Hayashi, in “Convex optimization-based signal detection for massive overloaded MIMO systems,” is to lower complexity uncoded signal detection for overloaded MIMO systems, which takes advantage of SOAV optimization (l₁-norm based algorithm).

Razvan-Andrei Stoica and Giuseppe Thadeu Freitas de Abreu, “Massively Concurrent NOMA: A Frame-Theoretic Design for Non-Orthogonal Multiple Access,” in Proc. Asilomar Conference on Signals, Systems and Computers, pp. 1-6, Pacific Grove, USA, November 2017, propose an original frame-theoretic design for NOMA systems, in which the mutual interference (MUI) of a large number of users is collectively minimized. This is achieved by precoding the symbols of each user with a distinct vector in a low-coherence tight frame, constructed either given an algebraic Harmonic technique for minimum-overloaded cases or given a complex sequential iterative decorrelation via convex optimization (CSIDCO) for generic frames. Therefore, the resulting massively concurrent non-orthogonal multiple access (MC-NOMA) enables all users to robustly and concurrently take advantage of the full orthogonal resources of the system simultaneously. The proposed strategy is therefore distinct from other coded NOMA approaches which seek to reduce the interference based exclusively on sparse access, at the penalty of limiting the resources allocated to each user. The BER, spectral efficiency and sum-rate gains obtained by MC-NOMA both against conventional orthogonal multiple access (OMA) and state-of-the-art NOMA systems are discussed and illustrated. Razvan-Andrei Stoica and Giuseppe Thadeu Freitas de Abreu, “Massively Concurrent NOMA: A Frame-Theoretic Design for Non-Orthogonal Multiple Access,” describes a multi-stage parallel interference cancellation-based signal detector for massively concurrent NOMA systems with low-complexity but reasonable BER performance.

T. Datta, N. Srinidhi, A. Chockalingam, and B. S. Rajan, “Low complexity near-optimal signal detection in underdetermined large MIMO systems,” in Proc. NCC, February 2012, pp. 1-5. propose a signal detection in N_{T}×N_{R} underdetermined MIMO (UD-MIMO) systems, where i) N_{T}>N_{R} with a overload factor α=N_{T} over N_{R}>1, ii) N_{T} symbols are transmitted per channel use through spatial multiplexing, and iii) N_{T}, N_{R} are large (in the range of tens). A low-complexity detection algorithm based on reactive Tabu search is considered. A variable threshold-based stopping criterion is proposed which offers near-optimal performance in large UD-MIMO systems at low complexities. A lower bound on the ML bit error performance of large UD-MIMO systems is also obtained for comparison. The proposed algorithm is shown to achieve BER performance close to the ML lower bound within 0.6 dB at an uncoded BER of 10⁻² in 16×8 V-BLAST UD-MIMO system with 4-QAM (32 bps/Hz). Similar near-ML performance results are shown for 32×16, 32×24 V-BLAST UD-MIMO with 4-QAM/16-QAM. A performance and complexity comparison between the proposed algorithm and the X-generalized sphere decoder (λ-GSD) algorithm for UD-MIMO shows that the proposed algorithm achieves almost the same performance of λ-GSD but at a significantly lesser complexity. This means T. Datta, N. Srinidhi, A. Chockalingam, and B. S. Rajan, “Low complexity near-optimal signal detection in underdetermined large MIMO systems,” discloses lower complexity signal detection for underdetermined MIMO systems with relatively small size of transmission signal dimensions.

Fadlallah, A. Aïssa-El-Bey, K. Amis, D. Pastor and R. Pyndiah, “New Iterative Detector of MIMO Transmission Using Sparse Decomposition,” IEEE Transactions on Vehicular Technology, vol. 64, no. 8, pp. 3458-3464, August 2015 addresses the problem of decoding in large-scale MIMO systems. In this case, the optimal ML detector becomes impractical due to an exponential increase in the complexity with the signal and the constellation dimensions. This paper introduces an iterative decoding strategy with a tolerable complexity order. This scientific paper considers a MIMO system with finite constellation and model it as a system with sparse signal sources. We propose an ML relaxed detector that minimizes the Euclidean distance with the received signal while preserving a constant norm of the decoded signal. It is shown that the detection problem is equivalent to a convex optimization problem, which is solvable in polynomial time. Two applications are proposed, and simulation results illustrate the efficiency of the proposed detector. Fadlallah, A. Aïssa-El-Bey, K. Amis, D. Pastor and R. Pyndiah, “New Iterative Detector of MIMO Transmission Using Sparse Decomposition,” describe 1₁-norm based signal detection algorithm based on a convex reformulation of ML. Difference from R. Hayakawa and K. Hayashi, in “Convex optimization-based signal detection for massive overloaded MIMO systems,” is, however, that it requires higher complexity due to the fact that quadratic programming needs to be solved via numerical convex solvers.

US 2018234948 discloses an uplink detection method and device in a NOMA system. The method includes: performing pilot activation detection on each terminal in a first terminal set corresponding to a NOMA transmission unit block repeatedly until a detection end condition is met, wherein the first terminal set includes terminals that may transmit uplink data on the NOMA transmission unit block; performing channel estimation on each terminal in a second terminal set that determined through the pilot activation detection within each repetition period, wherein the second terminal set includes terminals that have actually transmitted uplink data on the NOMA transmission unit block; and detecting and decoding a data channel of each terminal in the second terminal set within each repetition period. US 2018234948 describes a PDMA, pilot activation detection and heuristic iterative algorithm.

WO 2017071540 A1 discloses a signal detection method and device in a non-orthogonal multiple access, which are used for reducing the complexity of signal detection in a non-orthogonal multiple access. The method comprises: determining user nodes with a signal-to-interference-and-noise ratio greater than a threshold value, forming the determined user nodes into a first set, and forming all the user nodes multiplexing one or more channel nodes into a second set; determining a message transmitted by each channel node to each user node in the first set by means of the first L iteration processes, wherein L is greater than 1 or less than N, N being a positive integer; according to the determined message transmitted by each channel node to each user node in the first set by means of the first L iteration processes, determining a message transmitted by each channel node to each user node in the second set by means of the (L+1)^{th} to the N^{th} iteration processes; and according to the message transmitted by each channel node to each user node in the second set, detecting a data signal respectively corresponding to each user node. This means WO 2017071540 characterizes PDMA, thresholding-based signal detection, iterative log likelihood calculation.

US 2018102882 A1 describes a downlink NOMA using a limited amount of control information. A base station device that adds and transmits symbols addressed to a first terminal device and one or more second terminal devices, using portion of available subcarriers, includes: a power setting unit that sets the first terminal device to a lower energy than the one or more second terminal devices; a scheduling unit that, for signals addressed to the one or more second terminal devices, performs resource allocation that is different from resource allocation for a signal addressed to the first terminal device; and a modulation and coding scheme (MCS) determining unit that controls modulation schemes such that, when allocating resources for the signal addressed to the first terminal device, the modulation schemes used by the one or more second terminal devices, to be added to the signal addressed to the first terminal device, are the same. US 2018102882 A1 depicts a Power Domain NOMA, a transmit and a receive architecture design.

WO 2017057834 A1 publishes a method for a terminal to transmit signals on the basis of a non-orthogonal multiple access scheme in a wireless communication system may comprise the steps of: receiving, from a base station, information about a codebook selected for the terminal in pre-defined non-orthogonal codebooks and control information including information about a codeword selected from the selected codebook; performing resource mapping on uplink data to be transmitted on the basis of information about the selected codebook and information about the codeword selected from the selected codebook; and transmitting, to the base station, the uplink data mapped to the resource according to the resource mapping. WO 2017057834 reveals a Predesigned codebook-based NOMA, parallel interference cancellation, successive interference cancellation, a transmit and a receive architecture design.

WO 2018210256 A1 discloses a bit-level operation. This bit-level operation is implemented prior to modulation and resource element (RE) mapping in order to generate a NOMA transmission using standard (QAM, QPSK, BPSK, etc.) modulators. In this way, the bit-level operation is exploited to achieve the benefits of NOMA (e.g., improved spectral efficiency, reduced overhead, etc.) at significantly less signal processing and hardware implementation complexity. The bit-level operation is specifically designed to produce an output bit-stream that is longer than the input bit-stream, and that includes output bit-values that are computed as a function of the input bit-values such that when the output bit-stream is subjected to modulation (e.g., M-ary QAM, QPSK, BPSK), the resulting symbols emulate a spreading operation that would otherwise have been generated from the input bit-stream, either by a NOMA-specific modulator or by a symbol-domain spreading operation. WO 2018210256 offers a solution for bit-level encoding and NOMA transmitter design.

WO 2017204469 A1 provides systems and methods for data analysis of experimental data. The analysis can include reference data that are not directly generated from the present experiment, which reference data may be values of the experimental parameters that were either provided by a user, computed by the system with input from a user, or computed by the system without using any input from a user. It is suggested that another example of such reference data may be information about the instrument, such as the calibration method of the instrument.

KR 20180091500 A is a disclosure relating to 5th generation (5G) or pre-5G communication system to support a higher data rate than 4′th generation (4G) communication systems such as Long Term Evolution (LTE). The present disclosure is to support multiple access. An operating method of a terminal comprises the processes of: transmitting at least one first reference signal through a first resource supporting orthogonal multiple access with at least one other terminal; transmitting at least one second reference signal through a second resource supporting non-orthogonal multiple access with the at least one other terminal; and transmitting the data signal according to a non-orthogonal multiple access scheme with the at least one other terminal. KR 20180091500 draws a solution for NOMA transmission/reception methodology using current OMA (LTE) systems with Random access and user detection.

U.S. Pat. No. 8,488,711 B2 describes a decoder for underdetermined MIMO systems with low decoding complexity is provided. The decoder consists of two stages: 1. Obtaining all valid candidate points efficiently by slab decoder. 2. Finding the optimal solution by conducting the intersectional operations with dynamic radius adaptation to the candidate set obtained from Stage 1. A reordering strategy is also disclosed. The reordering can be incorporated into the proposed decoding algorithm to provide a lower computational complexity and near-ML decoding performance for underdetermined MIMO systems. U.S. Pat. No. 8,488,711 describes a Slab sphere decoder, underdetermined MIMO and with near ML performance.

JP 2017521885 A describes methods, systems, and devices for hierarchical modulation and interference cancellation in wireless communications systems. Various deployment scenarios are supported that may provide communications on both a base modulation layer as well as in an enhancement modulation layer that is modulated on the base modulation layer, thus providing concurrent data streams that are provided to the same or different user equipment's. Various interference mitigation techniques are implemented in examples to compensate for interfering signals received from within a cell, compensate for interfering signals received from other cell(s), and/or compensate for interfering signals received from other radios that may operate in adjacent wireless communications network. This means JP 2017521885 discloses a hierarchical modulation and interference cancellation for multi-cell/multi-user systems.

EP 3427389 A1 discloses a system and method of power control and resource selection in a wireless uplink transmission. An eNodeB (eNB) may transmit to a plurality of user equipments (UEs) downlink signals including control information that prompts the UEs to transmit non-orthogonal signals based on lower open loop transmit power control targets over wireless links exhibiting higher path loss levels. Lower open loop transmit power control targets may be associated with sets of channel resources with greater bandwidth capacities, such as non-orthogonal spreading sequences having higher processing gains and/or higher coding gains. When the eNB receives an interference signal over one or more non-orthogonal resources from the UEs, the eNB may perform signal interference cancellation on the interference signal to at least partially decode at least one of the uplink signals. The interference signal may include uplink signals transmitted by different UEs according to the control information. EP 3427389 gives a solution for Resource management (transmission power, time and frequency) and a transmission policy.

Generally spoken and as already indicated, given the continuously increasing demands of mobile data rates and massive wireless connectivity, future communications systems will confront the shortage of wireless resources such as time, space and frequency. One of the main challenges of such overloaded systems is detection at the receiver, since the conventional linear detection methods demonstrate high error floor. To overcome this issue, several novel methods based on sphere decoding have been proposed in the past, which illustrate their capability of reaching the optimal performance, however their complexity grows as it was shown in the cited prior art exponentially with the size of transmit signal dimensions (i.e., the number of users), thus preventing their application to practical use cases, like IoT and several others in future (wireless) scenarios.

Based on the cited prior, the following conclusions can be drawn. For relatively small systems (<30), sphere decoding based algorithms asymptotically reach the performance of the ML detection, with relatively lower complexity compared with ML. For large systems, however, such sphere decoding based algorithms are prohibitively computationally demanding. Therefore, lower complexity alternatives have been proposed in the past. Specifically, sparse reconstruction algorithms such as SOAV have shown superior BER performance with significantly lower complexity. However, the related state-of-the-arts have been developed based on an l₁-norm approximation (using a certain mathematical structure). Most of these schemes of the cited Prior Art are based on l₁-norm based signal detection algorithm which leads to medium to high complexity and lacking scalability. In addition, error-floor performance is usually found, meaning that the performance is bounded regardless of the condition of the wireless channel, the energy-per-bit-to-noise ratio. While the SOAV decoder was found to outperform other state-of-the-art schemes, in terms of superior BER performance with significantly lower complexity, a shortfall of SOAV is that the l₀-norm regularization function employed to capture the discreteness of input signals is replaced by an l₁-norm approximation, leaving potential for further improvement.

One very fundamental problem associated to the existing proposals/schemes/methods is the lack of scalability, i.e., feasible complexity when the number of users sharing the resources is very high. This is one of the aspects addressed by the proposed invention.

It is clear that none of the proposed features described in the Prior Art fulfils the discussed scalability. Thus, the proposed invention addresses this gap, and subsequent evolution will focus on further reduced complexity, performance, and other practical aspects, such imperfect channel state information. In this context large combinatorial problems (like decoding in NOMA) make it convex problem impossible to guarantee that the best solution will be found, perhaps not even a good solution. In convex problems finding the best/optimal solution is always possible, without saying anything about the complexity at this point. A solution in this context can be regarded as a configuration that makes the system work, i.e., the messages/communications from all the users will be properly received and/or decoded.

In this context, large systems mean a system with the ability to serve more users simultaneously, which is very important. However, prohibitive complexity jeopardizes scalability, and hence, NOMA-based systems are not practically feasible as it is desired nowadays. The proposed invention is a key to tackle the complexity issue by transforming a combinatorial into a convex problem, thus making NOMA much more practical. As solution to that problem this invention contributes four different detection methods for large multidimensional signal reconstruction schemes capable of taking advantage of the signal's discreteness to enable efficient symbol detection.

This invention deals with the symbol detection problem of large multidimensional wireless communication systems in underloaded, fully-loaded and overloaded scenarios, in which multiple streams of discrete signals sampled from an alphabet of finite cardinality known to the receiver share the same channel. In other words, decoding (reception) of concurrent communications in overloaded wireless systems, i.e., systems in which different transmitters share the same radio resources (e.g., spectrum) at the same time. In this context, decoding is challenging due to the computational complexity that is required, especially when the number of users grows.

It is, thus, an object of the present invention to provide an improved method for Wireless X2X Access Method and Receivers for Large Multidimensional Wireless Systems.

### BRIEF SUMMARY

This invention present four computer-implemented receiver method of estimating transmit symbol vectors transmitted in an overloaded communication channel for both determined and underdetermined large-scale wireless systems, none of which resorts to the usual relaxation of l₀-norm by l₁-norm and all of which exhibit better performance and lower complexity than state-of-the-arts. The main idea of the proposed receiver methods is to reformulate the combinatorial ML detection problem via a non-convex (but continuous) l₀-norm constraint, which enables to convexify the problem so as to reduce the computational complexity while possessing the potential to achieve near ML performance. Taking advantage of an adaptable l₀-norm approximation and for one method a fractional programming technique, this invention introduces a convexified optimization problem and proposed a closed form iterative four detection/decoder methods.

The first computer-implemented receiver method of estimating transmit symbol vectors transmitted in an overloaded communication channel, indicated as discreteness-aware penalized zero-forcing receiver-method (DAPZF) and designed to offer a lower complexity alternative generalizes the well-known zero-forcing receiver to the context of discrete input.

The second computer-implemented receiver method of estimating transmit symbol vectors transmitted in an overloaded communication channel, named the discreteness-aware generalized eigenvalue receiver-method (DAGERM), not only offers a trade-off between performance and complexity compared, but also differs from by not requiring a penalization parameter to be set as an improved solution to the first receiver-method. Furthermore, in some critical circumstances within a transmission it was figured out that first receiver-method may occasionally suffer from numerical instabilities, in which the detection problem is formulated as a quadratically constrained quadratic program with one inequality constraint (QCQP-1) and solved with basis on More's Theorem.

A third computer-implemented receiver method of estimating transmit symbol vectors transmitted in an overloaded communication channel is a variation in which the alternating direction method of multipliers (ADMM) was incorporated, so as to yield a stand-alone solution.

A fourth computer-implemented receiver method of estimating transmit symbol vectors transmitted in an overloaded communication channel, named Mixed-Norm Discrete Vector (MDV) Decoder method is described. This approach relies on a weighted mixed-norm (l₀ and l₂) regularization, with the l₀-norm substituted by a continuous approximation governed by a smoothing parameter α. The resulting objective, while not convex, is locally convexified via the application Fractional Programming (FP), yielding an iterative convex problem with a convex constraint, which can be solved employing interior point methods. Motivated by the fact that the described recovery problem associated with the detection of overloaded systems can be solved in a stand-alone fashion, with yet the second method in which the original problem is again reformulated so as to allow for a closed-form solution. To this end, the weighted mixed-norm regularization is this time directly locally approximated by means of the application of the FP principle.

Since we addressed a generic multidimensional signal detection problem, the proposed methods can be applied to a wide range of applications in wireless communications (e.g., 6G wireless, next generation systems, Internet of Everything, vehicular communications, intra-car communications, smart cities, smart factory) and other fields, such as image/video processing and bio-image processing.

The invention recognizes that, since the symbols used in digital communications are ultimately transmitted as analogue signals in the analogue, i.e., continuous domain, and attenuation, intermodulation, distortion and all kinds of errors are unavoidably modifying the signals on their way from the transmitter through the analogue communication channel to the receiver, the “detection” of the transmitted symbol in the receiver remains foremost an “estimation” of the transmitted signal, irrespective of the method used and, as the signals are in most if not all cases represented by signal amplitude and signal phase, in particular to the estimation of the transmitted signal's vector. However, in the context of the present specification the terms “detecting” and “estimating” are used interchangeably, unless a distinction there between is indicated by the respective context. Once an estimated transmitted signal's vector is determined it is translated into an estimated transmitted symbol, and ultimately provided to a decoder that maps the estimated transmitted symbol to transmitted data.

A great advantage is the possible guaranteed connectivity and technical feasibility in very congested locations, like city-centers or industrial plants and enabling IoT connectivity for all sensors in auto and in non-auto products.

In the context of the present specification and claims, a communication channel is characterized by a set or matrix of complex coefficients. The channel matrix may also be referred to by the capital letter H. The communication channel may be established in any suitable medium, e.g., a medium that carries electromagnetic, acoustic and/or light waves. It is assumed that the channel properties are perfectly known and constant during each transmission of a symbol, i.e., while the channel properties may vary over time, each symbol's transmission experiences a constant channel.

The expression “symbol” refers to a member of a set of discrete symbols cᵢ, which form a constellation C of symbols or, more profane, an alphabet that is used for composing a transmission. A symbol represents one or more bits of data and represents the minimum amount of information that can be transmitted at a time in the system using constellation C. In the transmission channel a symbol may be represented by a combination of analogue states, e.g., an amplitude and a phase of a carrier wave. Amplitude and phase may, e.g., be referred to as a complex number or as ordinate values over an abscissa in the cartesian plane, and may be treated as a vector. A vector whose elements are symbols taken from C is referred herein by the small letter s. Each transmitter may use the same constellation C for transmitting data. However, it is likewise possible that the transmitters use different constellations. It is assumed that the receiver has knowledge about the constellations used in the respective transmitters.

A convex domain is a domain in which any two points can be connected by a straight line that entirely stays within the domain, i.e., any point on the straight line is a point in the convex domain. The convex domain may have any dimensionality, and the inventors recognize that the idea of a straight line in a 4-or-more-dimensional domain may be difficult to visualise.

The terms “component” or “element” may be used synonymously throughout the following specification, notably when referring to vectors.

As was mentioned before, in typical ML detection schemes one constraint is the strong focus on the discrete signal vectors for symbols cᵢ of the constellation C, which prevents using, e.g., known-effective fractional programming (FP) algorithms for finding the signal vector and thus the symbol having the minimum distance to the received signal's vector. The strong focus is often expressed through performing individual calculations for symbols of the constellation C in equations describing the detection. Some schemes try to enable the use of FP algorithms for estimating the most likely transmitted symbol and replace the individual calculations for symbols by describing the discreteness of the constellation C through a l₁-norm that is continuous and can thus be subjected to FP algorithms for finding minima. However, using the l₁-norm introduces a fair amount of estimation errors, which is generally undesired.

The detection scheme for overloaded systems of the method presented herein does not rely on the loose relaxation of the l₀-norm by resorting to a l₁-norm. Rather, in the inventive method a function ƒ₂ that is a tight l₀-norm approximation is employed, which allows utilizing an efficient and robust FP framework for the optimization of non-convex fractional objectives, which is less computationally demanding, and shown via simulations to outperform SOAV.

### BRIEF DESCRIPTION OF THE DRAWINGS

The invention will be further explained with reference to the drawings in which

FIG. 1 shows a simplified schematic representation of orthogonal multiple access to a shared medium,

FIG. 2 shows a simplified schematic representation of non-orthogonal access to a shared medium,

FIG. 3 shows an exemplary generalized block diagram of a transmitter and a receiver that communicate over a communication channel,

FIG. 4 shows an exemplary flow diagram of method steps implementing embodiments 4 of the present invention,

FIG. 5 shows details of method steps of the embodiments 4 of the present invention,

FIG. 6 shows exemplary and basic examples of a constellation, a transmitted and a received signal,

FIG. 7 shows a simplified exemplary graphical representation of the third function determined in accordance with the present invention, that can be effectively solved using fractional programming.

FIG. 8 shows an exemplary flow diagram of core method steps implementing embodiments 1 of the present invention of the receiver method 3,

FIG. 9 shows an exemplary flow diagram of method steps implementing embodiments 1 of the present invention of the receiver method 3,

FIG. 10 shows an exemplary flow diagram of core method steps implementing embodiments 2 of the present invention,

FIG. 11 shows an exemplary flow diagram of method steps implementing embodiments 2 of the present invention,

FIG. 12 shows an exemplary flow diagram of core method steps implementing embodiments 3 of the present invention,

FIG. 13 shows an exemplary flow diagram of method steps implementing embodiments 3 of the present invention.

### DETAILED DESCRIPTION

In the following, the general theoretical base of the inventive receiver methods will be explained with reference to an exemplary underdetermined wireless system with N_{T} transmitters and N_{R}<N_{T} receive resources, such that the overloading ratio of the system is given by y=N_{T}/N_{R} and the received signal, after well-known signal realization, can be modelled as

$$y = Hs + n \qquad ( 1 )$$

$$where$$

$$H {=}^{△} [ \begin{matrix}Re \{ H \} & - Im \{ H \} \\ Im \{ H \} & Re \{ H \}\end{matrix} ] , \qquad s {=}^{△} [ \begin{matrix}Re \{ s \} \\ Im \{ s \}\end{matrix} ] , \qquad n {=}^{△} [ \begin{matrix}Re \{ n \} \\ Im \{ n \}\end{matrix} ] ,$$

s=[s₁, . . . sN_{T}]^{T} ∈ [symbol] ^{N}^{_{T}} is a transmit symbol vector with each element sampled from a constellation set C of cardinality 2^{b}, with b denoting the number of bits per symbol, n ∈ [symbol] ^{N}^{_{R}}^{×1} is a circular symmetric complex additive white Gaussian noise (AWGN) vector with zero mean and covariance matrix σₙ²I_{N}_{_{R}}, and H ∈ [symbol] ^{N}^{_{R}}^{×N}^{_{T}} describes a flat fading channel matrix between the transmitter and receiver sides.

In conventional detectors a ML detection may be used for estimating a transmit signal vector s^{ML} for a received signal y. The ML detection requires determining the distances between the received signal vector y and each of the symbol vectors s of the symbols cᵢ of the constellation C. The number of calculations exponentially increases with the number N_{T} of transmitters.

The discreteness of the target set to the ML function prevents using effective FP algorithms, which are known to be effective for finding minima in functions having continuous input, for estimating the transmit signal vector ŝ for a received signal y.

In accordance with the present invention the discrete target set for the ML function is first transformed into a sufficiently similar continuous function, which is open to solving through FP algorithms.

To this end, the alternative representation of the discrete ML function

$${s}^{ML} = {argmin}_{s ∈ {ℝ}^{2 {N}_{t}}} {‖ y - Hs ‖}_{2}^{2} \qquad ( 2 a )$$

$$s . t .$$

$${{\sum }_{i = 1}}^{{2}^{\frac{b}{2}}} {\vert s - {x}_{i} 1 \vert}_{0} = 2 {N}_{T} \cdot ( {2}^{\frac{b}{2}} - 1 ) \qquad ( 2 b )$$

is first transformed into a penalized mixed l₀-l₂ minimization problem that retains ML-like performance for the approximation of the constraint:

$${\tilde{s}}^{ML} = {arg min}_{s ∈ {ℝ}^{2 {N}_{t}}} {\sum }_{i = 1}^{{2}^{\frac{b}{2}}} {w}_{i} {‖ s - {x}_{i} 1 ‖}_{0} + λ {‖ y - Hs ‖}_{2}^{2} \qquad ( 3 )$$

$$Function 7$$

where wᵢ and λ are weighting parameters. The notation \tilde{s}^{ML} indicates that the approximation still has the potential to achieve near-ML performance, as long as the weights wᵢ and λ are properly optimized. N_{T} is the number of transmitters and may also be referred to by N_{T}. Furthermore we name equation 2 as function 7.

Aiming to tackle the intractable non-convexity of l₀-norm in the novel reformulation of the ML detection without resorting to the l₁-norm, it proves convenient to first introduce two different techniques. The former is an adoptable approximation of the l₀-norm function,

$${‖ x ‖}_{0} = {lim}_{α \to {0}^{+}} {\sum }_{j = 1}^{N} \frac{\vert {x}_{j} \vert}{\vert {x}_{j} \vert + α} = N - {lim}_{α \to {0}^{+}} {\sum }_{j = 1}^{N} \frac{α}{\vert {x}_{j} \vert + α} = {lim}_{α \to {0}^{+}} {\sum }_{j = 1}^{N} \frac{{\vert {x}_{j} \vert}^{2}}{{\vert {x}_{j} \vert}^{2} + α} = N - {lim}_{α \to {0}^{+}} {\sum }_{j = 1}^{N} \frac{α}{{\vert {x}_{j} \vert}^{2} + α} \qquad ( 9 )$$

$$Function 9$$

where x is an arbitrary sparse vector of length N. Notice that unlike the relaxation by l₁-norm substitution, the expression in equation (9) can be made arbitrarily tight by making a sufficiently small. On the other hand, the latter technique, referred to as quadratic transform (QT) is a transformation to solve an optimization problem involving sum of-ratio non-convex functions. While several methods such as the Taylor series approximation and the semidefinite relaxation (SDR) are known for the transformation of non-convex ratios functions in the past decade, the QT has shown superior performance in different optimization setups and wide applicability due to its tractable expression. Consider a generic maximization problem with a sum of ratios as objective, such as

$${max}_{x} {\sum }_{m = 1}^{M} {a}_{m}^{H} ( x ) {B}_{m}^{- 1} ( x ) {a}_{m} ( x ) \qquad ( 10 a )$$

$$s . t . x ∈ 𝒳 \qquad ( 10 b )$$

where aₘ (x) denotes an arbitrary complex vector function, Bₘ (x) is an arbitrary symmetric positive definite matrix, and x is a variable to be optimized in a constraint set [symbol] .

In the sequel, we propose QT-based several novel receiver method 1 to 4 via the flexible l₀-norm approximation given in equation (9), aiming at the bit error rate (BER) performance asymptotically close to the optimal ML detection while

General Theoretical Base for Receiver Method 1 (DAFZF)

It might be a practical bottleneck to compute a large number of iterations since the maximal number of iterations is not determined for known solutions while guaranteeing convergence. Motivated by the this, we therefore tackle equation/function (7) with the aim of reducing the algorithmic complexity as much as possible, proposing a new simple iterative algorithm/method with a closed-form solution to equation/function (7). To this end, we combine the quadratic approximation of the l₀-norm, resulting in

$$\begin{matrix}( P 3 ) ⇐ \{ {\tilde{s}}^{ML} = {arg min}_{s ∈ {ℂ}^{{N}_{T}}} {\sum }_{i = 1}^{{2}^{b}} {w}_{i} {‖ s - {c}_{i} 1 ‖}_{0} + λ {‖ y - Hs ‖}_{2}^{2} \\ \approx {arg min}_{s ∈ {ℂ}^{{N}_{T}}} {s}^{H} \hat{B} s - 2 R e \{ {\hat{b}}^{H} s \} + λ {‖ y - Hs ‖}_{2}^{2} \\ = {arg min}_{s ∈ {ℂ}^{{N}_{T}}} {s}^{H} \underbrace{( \hat{B} + λ {H}^{H} H ) s - 2 R e \{ ( {\hat{b}}^{H} + λ {y}^{H} H ) s \}}_{{=}^{△} f ( s )}\end{matrix} \qquad ( 35 )$$

$$Function 35$$

$$where \hat{B} = {\sum }_{i = 1}^{{2}^{b}} {w}_{i} diag ( {β}_{i , 1}^{2} , {β}_{i , 2}^{2} , … , {β}_{i , {N}_{t}}^{2} ) and \\ \hat{b} = {\sum }_{i = 1}^{{2}^{b}} {w}_{i} {{c}_{i} [ {β}_{i , 1}^{2} , {β}_{i , 2}^{2} , … , {β}_{i , {N}_{t}}^{2} ]}^{T}$$

One may notice that the above penalized minimization problem in (35) is a simple convex quadratic minimization, which can be efficiently solved by taking Wirtinger derivatives with respect to s* that is,

$$\frac{\partial f ( s )}{\partial {s}^{*}} = ( \hat{B} + λ {H}^{H} H ) s - ( \hat{b} + λ {H}^{H} y ) = 0 , \qquad ( 36 )$$

which yields

s^{opt}=(\hat{B}+λH^{H}H)⁻¹(\hat{b}+λH^{H}y). (37)

The simple and closed-form solution in equation (37) enables us to compute the optimal s^{opt} via only one matrix multiplication for a fixed B. Given the above, a pseudo code developed is illustrated.

Input y: Received signal vector;
H: Measurement compressive matrix:
λ: Balancing parameter;
α: Tightening parameter for l₀-norm approximation;
iₘₐₓ: Maximum number of iterations
ε: Iteration stop criterion

1 Set iteration counter i=0;

2 Generate uniformly distributed initial signal vector s⁽ⁱ⁾;

3 repeat:

$${β}_{i , j} = \frac{\sqrt{α}}{{( {s}_{j} - {x}_{i} )}^{2} + α} ;$$

8 until δ<ε or reach the maximum iteration iₘₐₓ;

General theoretical base for Receiver Method 2 (DAGED)

It can be noticed that as pointed out Receiver Method 3 and 1 have tackled the two different bottlenecks of Receiver Method 4, respectively. In other words, the ADMM-based approach in Receiver Method 3, described later, has been proposed to be a standalone method, in which the time efficiency might be limited due to the unlimited iterative mechanism, whereas Receiver Method 1 has rather aimed to improve the time efficiency by avoiding the iterative inner loop, imposing optimization of the penalty parameter λ before running the algorithm. Considering the above, in this subsection we therefore propose a non-iterative, in the sense of avoiding the inner loop, and stand-alone approach for equation (6) based on the generalized eigenvalue problem. Recalling equation (6), it can be formulated as a real-valued QCQP-1, that is,

$$( P 4 ) ⇐ \{ {arg min}_{s ∈ {ℝ}^{2 {N}_{t}}} {s}^{T} {G}_{H} s - 2 {y}^{T} Hs \qquad ( 38 )$$

$$s . t . g ( s ) = {s}^{T} {G}_{B} s - 2 {v}^{T} s + K \leq 0 \qquad ( 39 )$$

$$Function 38$$

$$where {G}_{H} = {H}^{T} H \\ {G}_{B} = {\sum }_{i = 1}^{{2}^{\frac{b}{2}}} diag ( {β}_{i , 1}^{2} , {β}_{i , 2}^{2} , … , {β}_{i , 2 {N}_{t}}^{2} ) and \\ v = {\sum }_{i = 1}^{{2}^{\frac{b}{2}}} {{x}_{i} [ {β}_{i , 1}^{2} , {β}_{i , 2}^{2} , … , {β}_{i , 2 {N}_{t}}^{2} ]}^{T} \qquad ( 39 )$$

with now

$${β}_{i , j} = \frac{\sqrt{α}}{{( {s}_{j} - {x}_{i} )}^{2} + α} and \\ K = {\sum }_{i = 1}^{{2}^{\frac{b}{2}}} {\sum }_{j = 1}^{2 {N}_{t}} {β}_{i , j}^{2} ( {x}_{i}^{2} + α ) - 2 {β}_{i , j} \sqrt{α} + 2 {N}_{t}$$

Given the More's theorem, assuming that the Slater's condition is satisfied, namely, there exists at least one feasible solution satisfying constraint (38b), s^{opt} is the global solution to equation (38) if and only if there exist μ^{opt}≥0 such that

$$( {G}_{H} + {μ}^{opt} {G}_{B} ) {s}^{opt} = ( {H}^{T} y + {μ}^{opt} v ) \qquad ( 40 a )$$

$$g ( {s}^{opt} ) \leq 0 \qquad ( 40 b )$$

$${μ}^{opt} g ( {s}^{opt} ) = 0 , \qquad ( 40 c )$$

which yield

(G_{H}+μ^{opt}G_{B})s^{opt}=(H^{T}y+μ^{opt}v) (41a)

g(s^{opt})=0, (41b)
or equivalently

$$\{ \begin{matrix}K θ - {v}^{T} {z}_{1} + {( {H}^{T} y + {μ}^{opt} v )}^{T} {z}_{2} = 0 \\ - v θ + {G}_{B} {z}_{1} - ( {G}_{H} + {μ}^{opt} {G}_{B} ) {z}_{2} = 0 \\ ( {H}^{T} y + {μ}^{opt} v ) θ - ( {G}_{H} + {μ}^{opt} {G}_{B} ) {z}_{1} = 0\end{matrix} where {s}^{opt} = \frac{{z}_{1}}{θ} \qquad ( 42 )$$

One may readily notice that the simultaneous equations in (42) can be rewritten as a generalized eigenvalue problem, namely,

$${M}_{0} + {μ}^{opt} {M}_{1} = [ \begin{matrix}K & - {v}^{T} & {( {H}^{T} y + {μ}^{opt} v )}^{T} \\ - v & {G}_{B} & - ( {G}_{H} + {μ}^{opt} {G}_{B} ) \\ ( {H}^{T} y + {μ}^{opt} v ) & - ( {G}_{H} + {μ}^{opt} {G}_{B} ) & {0}_{2 {N}_{t}}\end{matrix} ] z = 0 \qquad ( 43 )$$

$$Function 43$$

$$where {M}_{0} = [ \begin{matrix}K & - {v}^{T} & {y}^{T} H \\ - v & {G}_{B} & - {G}_{H} \\ {H}^{T} y & - {G}_{H} & {0}_{2 {N}_{t}}\end{matrix} ] and \\ {M}_{1} = [ \begin{matrix}0 & {0}_{1 \times 2 {N}_{t}} & {v}^{T} \\ {0}_{2 {N}_{t} \times 1} & {0}_{2 {N}_{t}} & - {G}_{B} \\ v & - {G}_{B} & {0}_{2 {N}_{t}}\end{matrix} ]$$

It proves convenient to apply a Möbius transformation to the matrix pencil in equation (43), resulting in the following inverted matrix pencil

$$( {M}_{1} + {ξ}^{opt} {M}_{0} ) z = 0 , \qquad ( 44 )$$

$$Function 44$$

$$where {ξ}^{opt} = \frac{1}{{μ}^{opt}} .$$

For the transformed generalized eigenvalue problem in equation (44), it has been shown that the optimal ξ^{opt} is the largest real finite generalized eigenvalue of the matrix pencil (44). Notice that the Mobius transformation technique enables us to avoid calculating the smallest real positive eigenvalue due to the well-known fact that computing the smallest eigenvalue may be inaccurate compared with the largest one. Given all the above, we summarize our method 4 as a pseudo code.

Input y: Received signal vector;
H: Measurement compressive matrix:
λ: Balancing parameter;
α: Tightening parameter for l₀-norm approximation;
iₘₐₓ: Maximum number of iterations
ε: Iteration stop criterion

1 Set iteration counter i=0;

2 Generate uniformly distributed initial signal vector s⁽ⁱ⁾;

3 repeat:

$${β}_{i , j} = \frac{\sqrt{α}}{{( {s}_{j} - {x}_{i} )}^{2} + α} ;$$

8 until δ<ε or reach the maximum iteration iₘₐₓ;

General theoretical base for Receiver Method 3 (DAPZF)

In order to improve the aforementioned receiver methods 3 overcomes the problem of the predefinition/optimization before running of receiver method 4. The suggested first step to obtaining a lower-complexity and stand-alone alternative to Receiver Method 4 is to recognize that the l₀-norm regularizer can be reformulated into a simple quadratic function with the aid of equation (9) and the QT technique. Plugging the second line of equation (9) into equation (5). The obtained result is:

$$( P 2 ) ⇐ \{ {arg min}_{s ∈ {ℂ}^{{N}_{t}}} {‖ y - Hs ‖}_{2}^{2} \qquad ( 18 a )$$

$$s . t . {N}_{t} - {\sum }_{i = 1}^{{2}^{b}} {\sum }_{j = 1}^{{N}_{t}} \frac{α}{{\vert {s}_{j} - {c}_{i} \vert}^{2} + α} \leq 0 , \qquad ( 18 b )$$

with a«1 and the identity

$${‖ s - {c}_{i} 1 ‖}_{0} \geq {N}_{t} - {\sum }_{j = 1}^{{N}_{t}} \frac{α}{{\vert {s}_{j} - {c}_{i} \vert}^{2} + α} . \qquad ( 19 )$$

Since equation (18b) is a differentiable concave-over-convex function with respect to s, QT can be directly applied to the above constraint, resulting in

$${arg min}_{s ∈ {ℂ}^{{N}_{t}}} {‖ y - Hs ‖}_{2}^{2} \qquad ( 20 a )$$

$$s . t . {N}_{t} - {\sum }_{i = 1}^{{2}^{b}} {\sum }_{j = 1}^{{N}_{t}} ( - {β}_{i , j}^{2} {\vert {s}_{j} \vert}^{2} + 2 {β}_{i , j}^{2} Re \{ {c}_{i} {s}_{j}^{*} \} - {β}_{i , j}^{2} ( {\vert {c}_{i} \vert}^{2} + α ) + 2 {β}_{i , j} \sqrt{α} ) \leq 0 , where {β}_{i , j} = \frac{\sqrt{α}}{{\vert {s}_{j} - {c}_{i} \vert}^{2} + α} \qquad ( 20 b )$$

For further simplification and tractability, the constraint in equation (20b) can be reformulated in a matrix form as follows:

$${\sum }_{i = 1}^{{2}^{b}} {\sum }_{j = 1}^{{N}_{t}} {β}_{i , j}^{2} {\vert {s}_{j} \vert}^{2} - 2 {\sum }_{i = 1}^{{2}^{b}} {\sum }_{j = 1}^{{N}_{t}} R e \{ {β}_{i , j}^{2} {c}_{i} {s}_{j}^{*} \} + {\sum }_{i = 1}^{{2}^{b}} {\sum }_{j = 1}^{{N}_{t}} {\overbrace{{β}_{i , j}^{2} ( {\vert {c}_{i} \vert}^{2} + α ) - 2 {β}_{i , j} \sqrt{α} + {N}_{t} \leq 0}}^{{=}^{Δ} δ} \qquad ( 21 )$$

$$⇔ {\underbrace{{s}^{H} Bs - 2 R e \{ {b}^{H} s \} + δ \leq 0}}_{Convex quadratic function i n s} where \\ B = {\sum }_{i = 1}^{{2}^{b}} diag ( {β}_{i , 1}^{2} , {β}_{i , 2}^{2} , … , {β}_{i , {N}_{t}}^{2} ) ⪰ 0 And \\ b = {\sum }_{i = 1}^{{2}^{b}} {{c}_{i} [ {β}_{i , 1}^{2} , {β}_{i , 2}^{2} , … , {β}_{i , {N}_{t}}^{2} ]}^{T} \qquad ( 22 )$$

Considering the above, equation (18) can be rewritten as a convex QCQP-1, that is,

$${arg min}_{s ∈ {ℂ}^{{N}_{t}}} {‖ y - Hs ‖}_{2}^{2} \qquad ( 23 a )$$

$$s . t . {s}^{H} Bs - 2 R e \{ {b}^{H} s \} + δ \leq 0 \qquad ( 23 b )$$

which can be equivalently rewritten as

$$𝒬 C 𝒬 P - 2 = 1 ⇐ \{ {arg min}_{s ∈ {ℂ}^{{N}_{t}}} {s}^{H} {H}^{H} Hs - 2 R e \{ {y}^{H} Hs \} \qquad ( 24 a )$$

$$s . t . {s}^{H} Bs - 2 R e \{ {b}^{H} s \} + δ \leq 0. \qquad ( 24 b )$$

Although the above QCQP-1 in equation (24) can be efficiently solved via interior point method by using numerical convex solvers, we remark that such black-box dependent algorithms often lead to not only an impractical in real-world implementation but also time inefficient solution for relatively large-scale problems. To efficiently solve the latter problem, the ADMM is leveraged below. ADMM algorithm has been invented to solve convex problems of the type

$${minimize}_{x , s} f ( x ) + g ( s ) \qquad ( 25 a )$$

$$s . t . {D}_{s} s + {D}_{x} x - c = 0 \qquad ( 25 b )$$

where f(x): Cⁿ→R and g(s): Cⁿ→R are closed, proper and convex functions with complex inputs x ∈ Cⁿ and s ∈ Cⁿ, respectively. Dₓ∈R^{n×n} and Dₛ∈R^{n×n} denote arbitrary matrices and c ∈Rⁿ is an arbitrary vector. Although in the above ADMM problem no assumption on finiteness and differentiability of ƒ(x) and g(z) has been made, the convergence of the iterative (scaled) ADMM algorithm for convex problems such as equation (25) has been shown with the following updates

$$s ← {arg min}_{s} f ( s ) + ρ {‖ {D}_{s} s + {D}_{x} x - c + u ‖}^{2} , \qquad ( 26 a )$$

$$x ← {arg min}_{x} g ( x ) + ρ {‖ {D}_{s} s + {D}_{x} x - c + u ‖}^{2} , \qquad ( 26 b )$$

$$u ← u + {D}_{s} s + {D}_{x} x - c , \qquad ( 26 c )$$

With ρ>0 denoting the augmented Lagrangian parameter, Equation (24) can be rewritten as the following alternating optimization problem

$${arg min}_{s , x ∈ {ℂ}^{{N}_{t}}} {s}^{H} {H}^{H} Hs - 2 R e \{ {y}^{H} Hs \} \qquad ( 27 a )$$

$$s . t . {x}^{H} Bx - 2 R e \{ {b}^{H} x \} + δ \leq 0 , \qquad ( 27 b )$$

$$x = s \qquad ( 27 c )$$

which yields the updates

$$s ← {s}^{H} ( {H}^{H} H + ρ {I}_{{N}_{t}} ) s - 2 R e \{ ( {y}^{H} H + {ρ ( x + u )}^{H} ) s \} , \qquad ( 28 a )$$

$$x ← {arg min}_{x ∈ {ℂ}^{{N}_{t}}} {‖ x - s + u ‖}^{2} \qquad ( 28 b )$$

subject to x^{H}Bx−2 Re{b^{H}x}+δ≤0,

u→u+x−s (28c)

For the update of s, the derivative simply yields a closed-form solution

s^{opt}→(H^{H}H+ρI_{N}_{ₜ})⁻¹(H^{H}y+ρ(x+u)). (29)

For the update of x, however, it is difficult to obtain a closed-form solution due to the quadratic constraint, resorting to the Lagrangian multiplier method with an objective function

[symbol]

(x,μ)=x^{H}(μB+I)x−2 Re{(μb+s−u)^{H}x}+μδ (30)

from which the optimal can be obtained by taking derivative

x^{opt}=(μB+I)⁻¹(μb+s−u) (31)

Notice that if the global minimizer x=s·u satisfies the inequality constraint in equation (28b), x=s·u is the solution; otherwise, the inequality must be satisfied as equality. Given the above discussion, substituting equation (31) into the equality constraint, we obtain

$$\overbrace{{\sum }_{i = 1}^{{N}_{t}} diag ( {B}_{i} ) \frac{{\vert μ {b}_{i} + {s}_{i} - {u}_{i} \vert}^{2}}{{( μ diag ( {B}_{i} ) + 1 )}^{2}} - 2 R e \{ {\sum }_{i = 1}^{{N}_{t}} \frac{{b}_{i}^{*} ( μ {b}_{i} + {s}_{i} - {u}_{i} )}{μ diag ( {B}_{i} ) + 1} \} + δ}^{{=}^{Δ} γ ( μ )} = 0 \qquad ( 32 )$$

where diag(·) denotes the i^{th} diagonal element of a matrix and (·) is i^{th} element of a vector. To find the optimal μ satisfying the above equality, in what follows we reveal that y(μ) is a strictly decreasing function over μ by showing (d y(μ)/d<0. To this end we obtain

$$\begin{matrix}\frac{d γ ( μ )}{d μ} = \begin{matrix}{\sum }_{i = 1}^{{N}_{t}} \frac{d}{d μ} ( diag ( {B}_{i} ) \frac{{\vert μ {b}_{i} + {s}_{i} - {u}_{i} \vert}^{2}}{{( μ diag ( {B}_{i} ) + 1 )}^{2}} ) - \\ \frac{d}{d μ} ( \frac{{b}_{i}^{*} ( μ {b}_{i} + {s}_{i} - {u}_{i} )}{μ diag ( {B}_{i} ) + 1} ) - \frac{d}{d μ} ( \frac{{{b}_{i} ( μ {b}_{i} + {s}_{i} - {u}_{i} )}^{*}}{μ diag ( {B}_{i} ) + 1} )\end{matrix} \\ = - 2 {\sum }_{i = 1}^{{N}_{t}} \frac{{\vert {b}_{i} \vert}^{2} + {diag ( B )}_{i}^{2} {\vert {s}_{i} - {u}_{i} \vert}^{2}}{{( 1 + μ diag ( {B}_{i} ) )}^{3}} < 0.\end{matrix} \qquad ( 33 )$$

Note that due to the fact that all the diagonal elements of B are nonnegative real values, y(μ) is a non-increasing function in μ≥0. Therefore, the optimal μ* satisfying y(μ*)=0 can be found via iterative root-finding algorithms such as bi-section and Newton's method.

s→(H^{H}H+ρI_{N}_{ₜ})⁻¹(H^{H}y+ρ(x+u)), (34a)

x→(μB+I)⁻¹(μb+s−u) (34b)
With optimal g vis solving (32)

u→u+x−s (34c)

Input y: Received signal vector;
H: Measurement compressive matrix:
α: Tightening parameter for l₀-norm approximation;
iₘₐₓ^{out}: Maximum number of outer iterations
iₘₐₓⁱⁿ: Maximum number of inner (ADMM) iterations
ε: Iteration stop criterion

1 Set iteration counter i=0;

2 Generate uniformly distributed initial signal vector \tilde{s}⁽ⁱ⁾;

3 repeat:

| | Input: y: Received signal vector; | | |
|---|---|---|---|
| | | | H: Measurement compressive matrix; |
| | | | a: Tightening parameter for [symbol] -norm approximation; |
| | | | iₘₐₓ^{out}: Maximum number of outer iterations |
| | | | iₘₐₓⁱⁿ: Maximum number of inner (ADMM) iterations |
| | | | E: Iteration stop criterion |
| 1 | Set interation counter i = 0; | | |
| 2 | Generate uniformly distributed initial signal vector [symbol] ⁽ⁱ⁾; | | |
| 3 | repeat | | |
| 4 | \| | $Update {β}_{ij} ∀ i , j by {β}_{ij} = \frac{\sqrt{a}}{{t}_{2 N} \text{?} + a} ;$ | |
| 5 | \| | i ← i + 1 and i ← 0; | |
| 6 | \| | repeat | |
| 7 | \| | \| | t ← t + 1 |
| 8 | \| | \| | s^{(t)} ← (H^{H}H + ρI_{N} [symbol] )⁻¹(H^{H}y + ρ(x^{(t-1)} + u^{(t-1)})) |
| 9 | \| | \| | μ^{(t)} ← Solve equation (32) via bi-section or Newton’s |
| | | | method |
| 10 | \| | \| | x^{(t)} ← (μ^{+(t)}B + I)⁻¹(μ^{(t)}b + s^{(t)} − u^{(t-1)}) |
| 11 | \| | \| | u^{(t)} ← u^{(t-1)} + x^{(t)} − s^{(t)} |
| 12 | \| | \| | Check convergence δ = \|\|s^{(t)} − s^{(t-1)}\|\|₂ |

| | | |
|---|---|---|
| 13 | \| | until δ < ε or reach the maximum iteration iₘₐₓⁱⁿ; |
| 14 | \| | [symbol] ⁽ⁱ⁾ ← s^{(t)} |
| 15 | \| | Check convergence \hat{δ} = \|\| [symbol] ^{(t)} − [symbol] ^{(t-1)}\|\|₂ |

| | |
|---|---|
| 16 | until \hat{δ} < ε or reach the maximum interation iₘₐₓ^{out}; |

[symbol]

indicates data missing or illegible when filed

16 until δ<ε or reach the maximum iteration iₘₐₓ^{out};

General Theoretical Base for Receiver Method 4

In order to address the intractable non-convexity of the l₀-norm without resorting to the l₁-norm, the l₀-norm is replaced with the asymptotically tight expression:

$${‖ x ‖}_{0} = {lim}_{α \to {0}^{+}} {\sum }_{j = 1}^{N} \frac{\vert {x}_{j} \vert}{\vert {x}_{j} \vert + α} = N - {lim}_{α \to {0}^{+}} {\sum }_{j = 1}^{N} \frac{α}{\vert {x}_{j} \vert + α} \qquad ( 4 )$$

where x is an arbitrary sparse vector of length T. The tight approximation of the l₀-norm is then used as a substitute of the l₀-norm in the penalized mixed l₀-l₂ minimization problem, and a slack variable tᵢⱼ, with the constraint |sⱼ−cᵢ|≤tᵢⱼ is introduced, yielding

$$\hat{s} = {arg min}_{\begin{matrix}s ∈ {ℝ}^{2 {N}_{t}} ; \\ t ∈ {ℝ}^{{2}^{\frac{b}{2} + 1} {N}_{t}}\end{matrix}} - {\sum }_{i = 1}^{{2}^{\frac{b}{2}}} {w}_{i} {\sum }_{j = 1}^{2 {N}_{t}} \frac{α}{{t}_{2 {N}_{t} ( i - 1 ) + j} + α} + λ {‖ y - Hs ‖}_{2}^{2} \qquad ( 5 a )$$

$$s . t . \vert {s}_{j} - {x}_{i} \vert \leq {t}_{2 {N}_{t} ( i - 1 ) + j} . \qquad ( 5 b )$$

with now α«1.
Since the ratios

$$\frac{α}{α + {t}_{2 {N}_{t} ( i - 1 ) + j}}$$

in equation (5a) possess a concave-over-convex structure due to the convex non-negative nominator and concave (linear) positive denominator, the required condition for convergence of the quadratic transform (QT) is satisfied, as has been shown by K. Shen and W. Yu in “Fractional programming for communication systems—Part I: Power control and beamforming,” IEEE Trans. Signal Process., vol. 66, no. 10, pp. 2616-2630, May 2018, such that equation (5a) can be reformulated into the following convex problem:

$$\hat{s} = {arg min}_{\begin{matrix}s ∈ {ℝ}^{2 {N}_{t}} ; \\ t ∈ {ℝ}^{{2}^{\frac{b}{2} + 1} {N}_{t}}\end{matrix}} {\sum }_{i = 1}^{{2}^{\frac{b}{2}}} {w}_{i} {\sum }_{j = 1}^{2 {N}_{t}} {β}_{ij}^{2} {t}_{2 {N}_{t} ( i - 1 ) + j} + λ {‖ y - Hs ‖}_{2}^{2} \qquad ( 6 a )$$

$$s . t . \vert {s}_{j} - {x}_{i} \vert \leq {t}_{2 {N}_{t} ( i - 1 ) + j} where {β}_{ij} {=}^{△} \frac{\sqrt{α}}{{t}_{2 {N}_{t} ( i - 1 ) + j} + α} . \qquad ( 6 b )$$

Thanks to the convergence of βᵢⱼ the equation can be solved through FP by iteratively updating βᵢⱼ and solving the equation for a given βᵢⱼ. The equation obtained by transforming the initial non-convex optimization problem into a convex optimization problem can be efficiently solved using known algorithms, such as augmented Lagrangian methods.

Thus, a computer-implemented method in accordance with the present invention of estimating transmit symbol vectors s transmitted in an overloaded communication channel that is characterized by a channel matrix H of complex coefficients includes receiving, in a receiver R, a signal represented by a received signal vector y. The received signal vector y corresponds to a superposition of signals representing transmitted symbol vectors s selected from a constellation C of symbols cᵢ that are transmitted from one or more transmitters, plus any distortion and noise added by the channel.

In case of more than one transmitter the transmitters T are temporally synchronized, i.e., a common time base is assumed between the transmitters T and the receiver R, such that the receiver R receives transmissions of symbols from different transmitters T substantially simultaneously, e.g., within a predetermined time window. The symbols being received simultaneously or within a predetermined time window means that all temporally synchronized transmitted symbols are received at the receiver R before subsequent symbols are received, assuming that a transmitter T transmits a sequence of symbols one by one. This may include settings in which transmitters T adjust the start time of their transmission such that a propagation delay, which depends on the distance between transmitter T and receiver R, is compensated for. This may also include that a time gap is provided between transmitting subsequent symbols.

The method further comprises defining a convex search space including at least the components of the received signal vector y and of the transmit symbol vectors s for all symbols cᵢ of the constellation C. Further, continuous first and second functions ƒ₁ and f₂ are defined in the search space. In this context, defining may include selecting factors or ranges of variables or the like for or in an otherwise predetermined function.

The continuous first function ƒ₁ is a function of the received signal vector y and the channel characteristics H and has a global minimum where the product of an input vector s from the search space and the channel matrix H equals the received signal vector y.

The continuous second function ƒ₂ is a function of input vectors s from the search space and has a significant low value for each of the transmit symbol vectors s of the symbols cᵢ of the constellation C.

In accordance with the invention the first function ƒ₁ and the second function ƒ₂ are combined into a third function h by weighted adding, and a fractional programming algorithm FP is applied to the third function ƒ₃, targeted to finding an input vectors that minimizes the third function ƒ₃. In other words, ŝ is the optimal solution or outcome of applying the FP algorithm to the third function h for which the third function ƒ₃ has a minimum.

Once an input vector ŝ that minimizes the third function h is found, a mapping rule is applied thereto that translates the input vectors into an estimated transmit vector ŝ_{C}, in which the index “C” indicates that every single component belongs to the constellation C. In other words, if the vector has two components, A and B, each of the components A and B of the input vectors that minimizes the third function h can have any value in the search space. These values are translated into values A′ and B′ of the estimated transmit vector gc, each of which can only have a value that occurs in any one of the transmit symbol vectors s for the symbols cᵢ of the constellation C. The components may be mapped separately, e.g., by selecting the closest value of a corresponding component of any of transmit symbol vectors s of the symbols cᵢ of the constellation C.

After the mapping the estimated transmit symbol vector ŝ_{C} is output to a decoder to obtain the data bits of the transmitted message.

In one or more embodiments the second function ƒ₂ has a tuneable factor that determines the gradient of the function in the vicinity of the significant low value at each of the vectors of the symbols of the constellation. The tuneable factor may help the FP algorithm to converge faster and/or to skip local minima that may be farther away from an optimal or at least better solution.

In some embodiments the tuneable factor may be different for different symbols of the constellation. For example, the gradient in the vicinity of a vector for a symbol that is farther away from the global minimum of the first function ƒ₁ may be very steep, but may be so only very close to the significant low value. Depending on the FP algorithm and the start value used this may help skipping local minima located at a greater distance from the global minimum of the first function ƒ₁ On the other hand, the gradient in the vicinity of a vector for a symbol that is located close to the global minimum of the first function ƒ₁ may be rather shallow at a certain distance to the significant low value and growing steeper as the distance shrinks. Depending on the FP algorithm used this may help the function to quickly converge to a significant low value.

In some embodiments the first function ƒ₁ is monotonously increasing from the global minimum. The first function may be considered a coarse guidance function for the FP algorithm, which helps the FP algorithm to converge. It is, thus, advantageous if the first function itself does not have any local minima.

A receiver of a communication system has a processor, volatile and/or non-volatile memory and at least one interface adapted to receive a signal in a communication channel. The non-volatile memory may store computer program instructions which, when executed by the microprocessor, configure the receiver to implement one or more embodiments of the method in accordance with the invention. The volatile memory may store parameters and other data during operation. The processor may be called one of a controller, a microcontroller, a microprocessor, a microcomputer and the like. And, the processor may be implemented using hardware, firmware, software and/or any combinations thereof. In the implementation by hardware, the processor may be provided with such a device configured to implement the present invention as ASICs (application specific integrated circuits), DSPs (digital signal processors), DSPDs (digital signal processing devices), PLDs (programmable logic devices), FPGAs (field programmable gate arrays), and the like.

Meanwhile, in case of implementing the embodiments of the present invention using firmware or software, the firmware or software may be configured to include modules, procedures, and/or functions for performing the above-explained functions or operations of the present invention. And, the firmware or software configured to implement the present invention is loaded in the processor or saved in the memory to be driven by the processor.

The present method addresses difficulties in applying effective FP algorithms for estimating candidates of transmitted symbol vectors arising from the discrete nature of the constellation by transforming the discrete constraint present in the known ML method for determining the Euclidian distance between the received signal's vector and the vectors of symbols of the constellation into a first function in a convex domain that presents significant low values for the vectors of symbols of the constellation. A minimum of the function in the convex domain can be found by applying known FP methods or algorithms that are more effective for finding a good estimate of a transmitted signal's vector than brute-force calculations. A second continuous function in the convex domain is added to the first function that penalizes estimation results with increasing distance from the received signal's vector.

While the invention has been described hereinbefore for detecting superimposed signals from transmitters that are all using the same constellation C it is also applicable to situations in which different transmitters use different constellations CT, i.e., if the symbols of a constellation C are considered letters of an alphabet, each transmitter may use a different alphabet.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts. In the drawings identical or similar elements may be referenced by the same reference designators.

In accordance with the embodiment(s) of the present invention, the components, process steps, and/or data structures described herein may be implemented using various types of operating systems, computing platforms, computer programs, and/or general-purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

### DETAILED DESCRIPTION

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

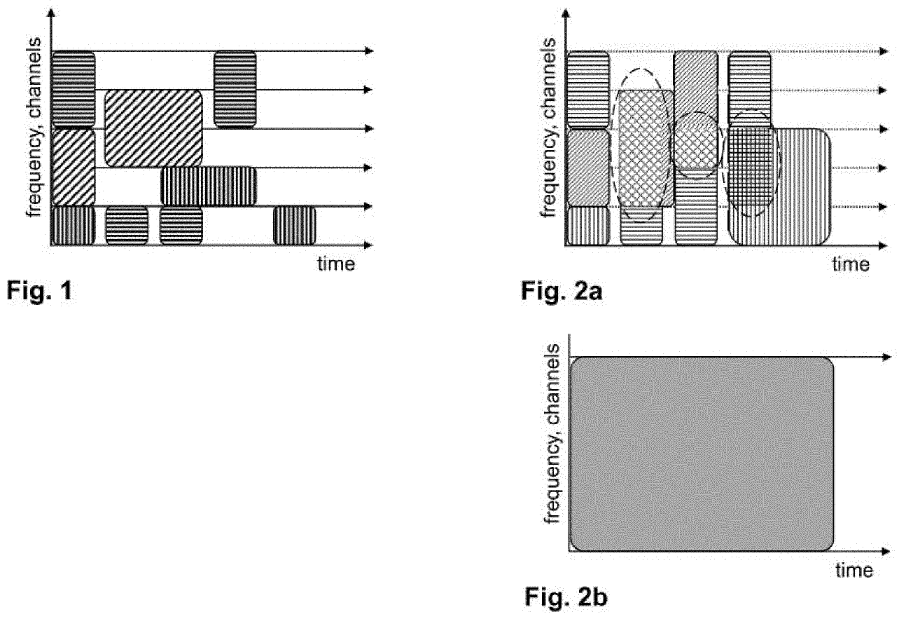

FIGS. 1 and 2 illustrate basic properties of orthogonal multiple access and non-orthogonal multiple access, respectively. FIG. 1 shows one exemplary embodiment of the ordered access of transmit resources to channels of a shared transmission medium, e.g., in a wireless communication system. The available frequency band is split into several channels. A single channel or a combination of contiguous or non-contiguous channels may be used by any one transmitter at a time. Different transmitters, indicated by the different hashing patterns, may transmit in discrete time slots or in several subsequent timeslots and may change the channels or combination of channels in which they transmit for each transmission. Note that, as shown in FIG. 1, any transmitter may use one channel resource over a longer period of time, while another transmitter may use two or more channel resources simultaneously, and yet another transmitter may to both, using two or more channel resources over a longer period of time. In any case, only one transmitter uses any channel resource or combination thereof at a time, and it is relatively easy to detect and decode signals from each transmitter.

FIG. 2a shows the same frequency band as shown in FIG. 1, but there may not always be a temporary exclusive assignment of one or more individual channels to a transmitter. Rather, at least a portion of the frequency band may concurrently be used by a plurality of transmitters, and it is much more difficult to detect and decode signals from individual transmitters. Again, different hashing patterns indicate different transmitters, and the circled portions indicate where wo or more transmitters concurrently use a resource. While, beginning from the left, at first three transmitters use temporary exclusive channel resources in an orthogonal manner, in the next moment two transmitters transmit in channels that partially overlap. The transmitter represented by the horizontal hashing pattern has exclusive access to the channel shown at the bottom of the figure, while the next three channels used by this transmitter are also used by another transmitter, represented by diagonal hashing pattern in the dashed-line oval. The superposition is indicated by the diagonally crossed hashing pattern. A similar situation occurs in the following moment, where each of two transmitters exclusively uses two channel resources, while both share a third one. It is to be noted that more than two transmitters may at least temporarily share some or all of the channel resources each of them uses. These situations may be called partial-overloading, or partial-NOMA.

In a different representation, FIG. 2b shows the same frequency band as FIG. 2a. Since there is no clear temporary exclusive assignment of one or more individual channels to a transmitter, and at least a portion of the frequency band is at least temporarily concurrently used by a plurality of transmitters, the difficulty to detect and decode signals from individual transmitters is indicated by the grey filling pattern that does not allow for identifying any single transmitter. In other words, all transmitters use all channels.

Signals from some transmitters may be transmitted using higher power than others and may consequently be received with a higher signal amplitude, but this may depend on the distance between transmitter and receiver. FIGS. 2a and 2b may help understanding the situation found in non-orthogonal multiple access environments.

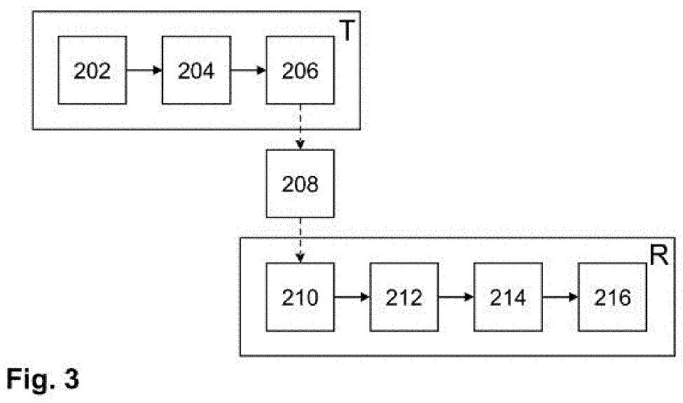

FIG. 3 shows an exemplary generalized block diagram of a transmitter T and a receiver R that communicate over a communication channel 208. Transmitter T may include, inter alia, a source 202 of digital data that is to be transmitted. Source 202 provides the bits of the digital data to an encoder 204, which forwards the data bits encoded into symbols to a modulator 206. Modulator 206 transmits the modulated data into the communication channel 208, e.g. via one or more antennas or any other kind of signal emitter (not shown). The modulation may for example be a Quadrature Amplitude Modulation (QAM), in which symbols to be transmitted are represented by an amplitude and a phase of a transmitted signal.

Channel 208 may be a wireless channel. However, the generalized block diagram is valid for any type of channel, wired or wireless. In the context of the present invention the medium is a shared medium, i.e., multiple transmitters and receivers access the same medium and, more particularly, the channel is shared by multiple transmitters and receivers.

Receiver R receives the signal through communication channel 208, e.g., via one or more antennas or any other kind of signal receiver (not shown). Communication channel 208 may have introduced noise to the transmitted signal, and amplitude and phase of the signal may have been distorted by the channel. The distortion may be compensated for by an equalizer provided in the receiver (not shown) that is controlled based upon channel characteristics that may be obtained, e.g., through analysing pilot symbols with known properties transmitted over the communication channel. Likewise, noise may be reduced or removed by a filter in the receiver (not shown). A signal detector 210 receives the signal from the channel and tries to estimate, from the received signal, which signal had been transmitted into the channel. Signal detector 210 forwards the estimated signal to a decoder 212 that decodes the estimated signal into an estimated symbol. If the decoding produces a symbol that could probably have been transmitted it is forwarded to a de-mapper 214, which outputs the bit estimates corresponding to the estimated transmit signal and the corresponding estimated symbol, e.g., to a microprocessor 216 for further processing. Otherwise, if the decoding does not produce a symbol that is likely to have been transmitted, the unsuccessful attempt to decode the estimated signal into a probable symbol is fed back to the signal detector for repeating the signal estimation with different parameters. The processing of the data in the modulator of the transmitter and of the demodulator in the receiver are complementary to each other.

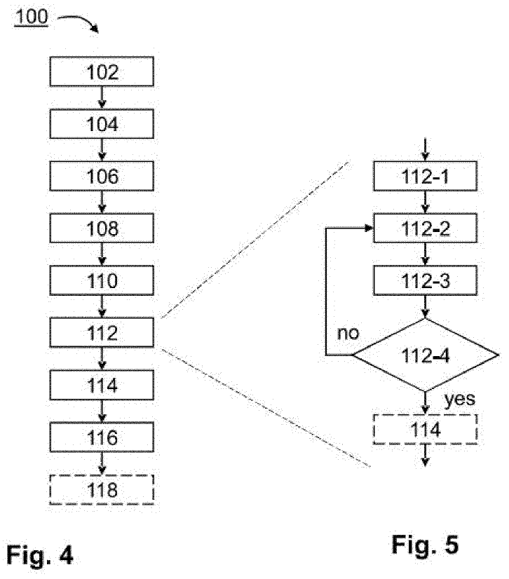

While the transmitter T and receiver R of FIG. 3 appear generally known, the receiver R, and more particularly the signal detector 210 and decoder 212 of the receiver in accordance with the invention are adapted to execute the inventive method described hereinafter with reference to FIG. 4 and thus operate different than known signal detectors.

FIG. 4 shows an exemplary flow diagram of method steps implementing embodiments of the present invention. In step 102 a signal is received in an overloaded communication channel. The signal corresponds to a superposition of signals representing transmitted symbols selected from a constellation C of symbols cᵢ and transmitted from one or more transmitters T. In step 104 a search space is defined in a convex domain including at least the components of the received signal vector y and of transmit symbol vectors s for all symbols cᵢ of the constellation C. In step 106 a continuous first function ƒ₁ is defined, which is a function of the received signal vector y and the channel characteristics H. The first function ƒ1 has a global minimum where the product of an input vector s from the search space and the channel matrix H equals the received signal vector y. Further, in step 108 a continuous second function ƒ₂ is defined in the search space, which is a function of input vectors s from the search space. The second function ƒ₂ has a significant low value for each of the transmit symbol vectors s of the symbols cᵢ of the constellation C. It is to be noted that steps 104, 106 and 108 need not be executed in the sequence shown in the figure, but may also be executed more or less simultaneously, or in a different sequence. The first and second functions ƒ₁, ƒ₂ are combined to a third continuous function h in step 110 through weighted adding. Once the third function h is determined a fractional programming algorithm is applied thereto in step 112 that is targeted to finding an input vector that minimizes the third function h. The input vectors that is the result output from the fractional programming algorithm is translated, in step 114, into an estimated transmit vector Sc, in which every single component has a value from the list of possible values of corresponding components of transmit symbol vectors s of the symbols cᵢ of the constellation C. The translation may include selecting the value from the list that is nearest to the estimated value. The estimated transmit vector Sc is then output in step 116 to a decoder for decoding into an estimated transmitted symbol c from the constellation C. The transmitted symbol c may be further processed into one or more bits of the data that was transmitted, step 118.

FIG. 5 shows details of the method steps of the present invention executed for finding an input vectors that minimizes the third function h, in particular the function according to equation 6 described further above. In step 112-1 the fractional programming is initialised with a start value for the estimated transmit signal's vector ŝₛₜₐᵣₜ, and βᵢⱼ is determined in step 112-2 for the start value of the estimated transmit vector ŝₛₜₐᵣₜ. Then, a new candidate for ŝ is derived in step 112-3 by solving the equation for the value βᵢⱼ determined in step 112-2. If the solution does not converge, “no”-branch of step 112-4, the value βᵢⱼ is determined based on the new candidate derived in step 112-3 and the equation-solving process is repeated. If the solution converges, “yes”-branch of step 112-4, ŝ forwarded to step 114 of FIG. 4, for mapping the estimated transmit vector Sc whose components assume values from vectors s of symbols cᵢ from the constellation C.

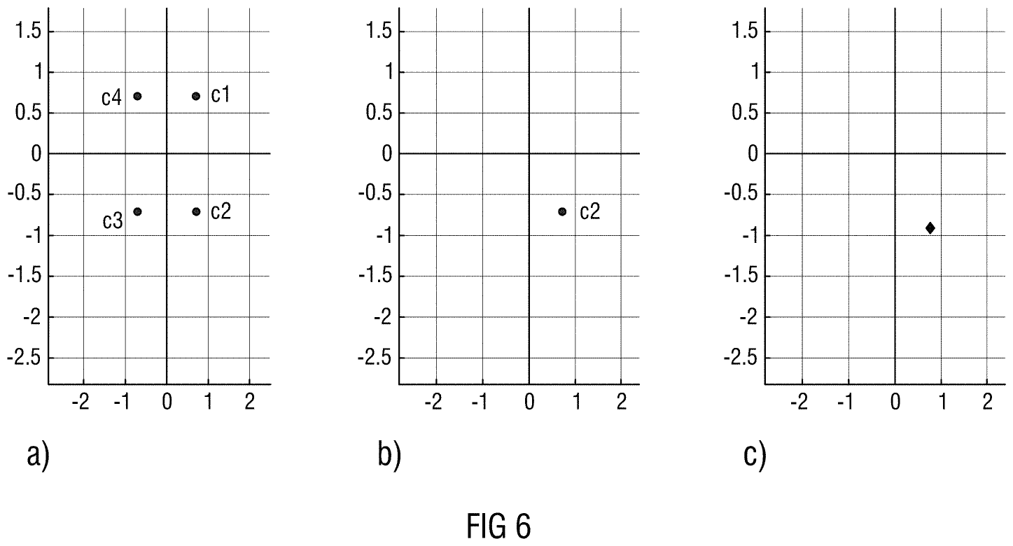

FIG. 6 a) shows exemplary and very basic examples of symbols c₁, c₂, c₃ and c₄ from a constellation C. The symbols c₁, c₂, c₃ and c₄ may represent symbols of a QAM-modulation. FIG. 6b) shows a symbol that was actually transmitted over a channel, in this case symbol c₂. FIG. 6c) shows the signal that was actually received at a receiver. Due to some distortion and noise in the channel the received signal does not lie exactly at the amplitude and phase of symbol c₂ that was sent. A maximum likelihood detector determines the distances between the received signal and each of the symbols from the constellation and would select that one as estimated symbol that is closest to the received signal. In the very simple example, this would be symbol c₂. This process requires performing calculations for all discrete pairs of received signal and symbols from the constellation, and may result in a number of calculations that exponentially increases with the number of symbols in the constellation and the number of transmitters that possibly transmitted the signal.

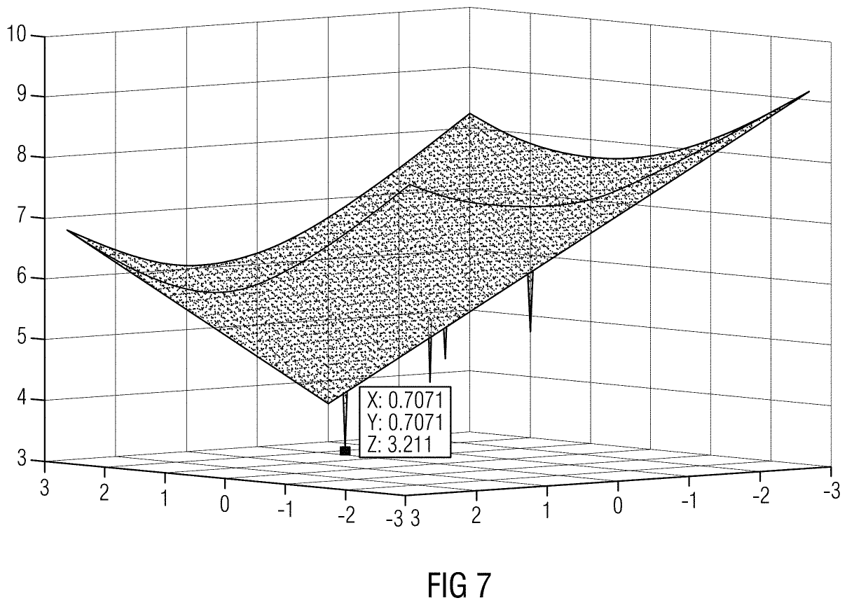

FIG. 7 shows a simplified exemplary graphical representation of the third function determined in accordance with the present invention that can be effectively solved using fractional programming.

The graphical representation is based on the same constellation as presented in FIG. 6a), and it is assumed that the same signal c₂ was transmitted. The bottom surface of the three-dimensional space represents the convex search space for amplitudes and phases of signal vectors. The vertical dimension represents the values for the third function. Since the search space is convex, the third function has values for any combination of amplitude and phase, even though only 4 discrete symbols c₁, c₂, c₃ and c₄ are actually in the constellation. The surface having a shape of an inverted cone represents the results of the continuous first function over the convex search space and has a global minimum at the location of the received signal. The 4 spikes protruding downwards from the cone-shaped surface represent the continuous second function that has significant low values at the phases and amplitudes of the symbols from the constellation. The first and second function have been combined into the third function, which is still continuous, and which can now be subjected to a fractional programming algorithm for finding the amplitude and phase that minimizes the third function. It is to be borne in mind that this representation is extremely simplified, but it is believed to help understanding the invention.

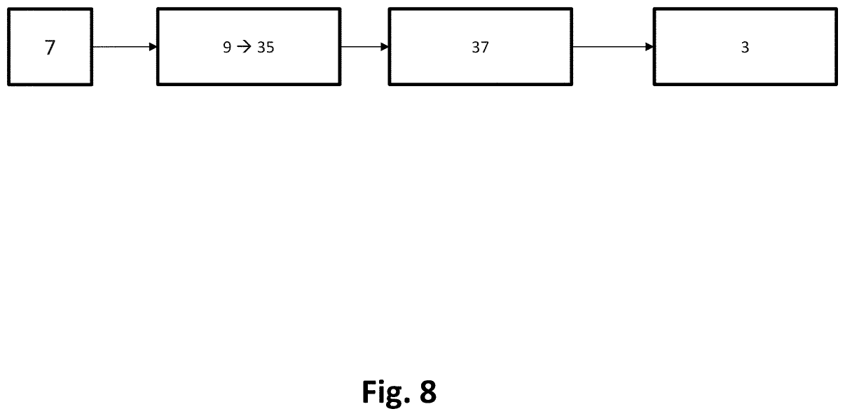

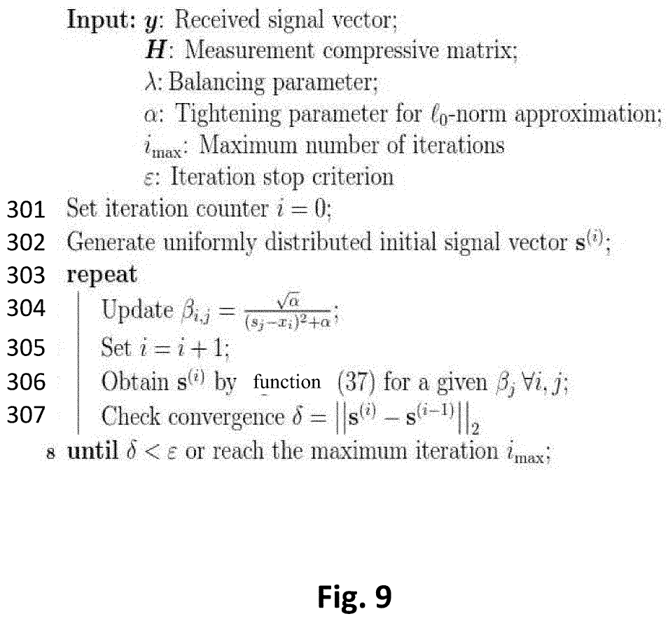

FIGS. 8 and 9 are the embodiment of a computer-implemented receiver method 3 of estimating transmit symbol vectors transmitted in an overloaded communication channel that is characterized by a channel matrix of complex coefficients, is described. The method receives 102, in a receiver R, a signal represented by a received signal vector. This received signal vector corresponding to a superposition of signals representing transmitted symbols selected from at least one constellation of symbols and transmitted from one or more transmitters T. Furthermore a defining 104 of a search space in a convex domain including at least a differentiable and convex function 37 in a closed form of the received signal vector and of transmit symbol vectors for all symbols of the at least one constellation is done.

In order obtaining the differentiable and convex function 37 in a closed form the first optimization formulation given by a first function 7 in recalculated into a second optimization formulation given as a second function 35. This is done by applying a quadratic approximation of l₀-norm given as third function 9 and after obtaining the second function 35 a forth function 36 is calculated. In order to obtain the differentiable and convex function 37, which is the core element of the receiver method 3, in a closed form of the received signal vector and of transmit symbol vectors is obtained by applying the setting of the Wingerts derivative of the forth function 36. Afterward the optimal solution (s^{opt}) calculated via a matrix multiplication for the fixed elements of the second function 35 is done, like it is shown in FIG. 9 step 306. By checking the convergence 6 given in step 307 iterative procedure is performed to find the optimal solution (s^{opt}) for the estimation of transmitting symbols.

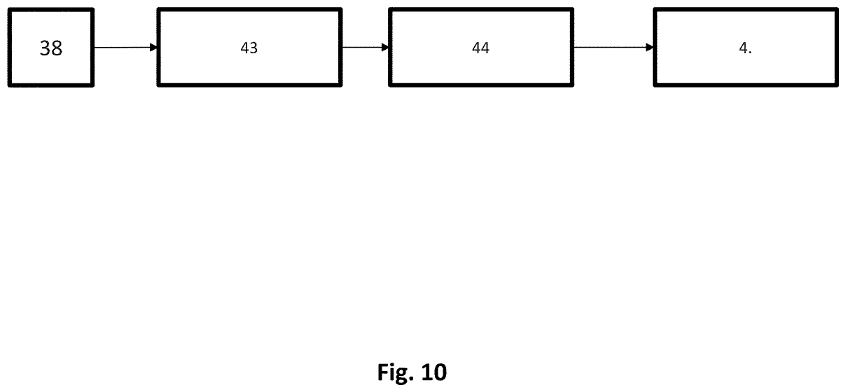

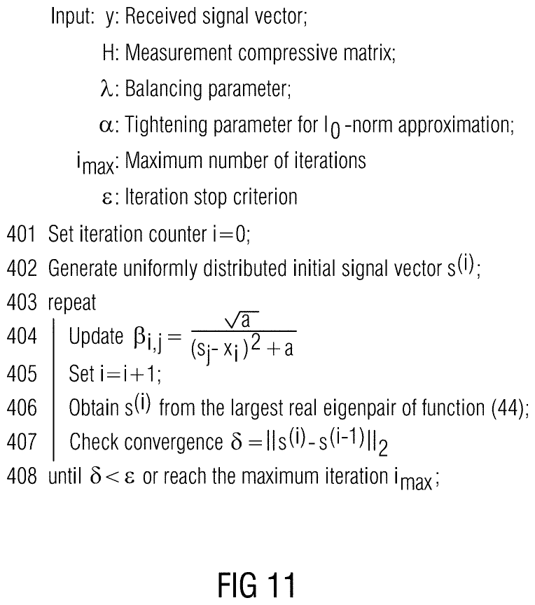

FIGS. 10 and 11 are illustrating the second embodiment of the computer-implemented receiver method 4 of estimating transmit symbol vectors transmitted in an overloaded communication channel. The channel is characterized by a channel matrix of complex coefficients.

This second the method 4 includes the received signal vector corresponding to a superposition of signals representing transmitted symbols selected from at least one constellation of symbols and transmitted from one or more transmitters T. Furthermore defining 104 of a search space in a convex domain including is done by defining 104 a search space in a convex domain including at least closed-form solution providing s and penalty parameter λ covering fifth function 44 of the received signal vector and of transmit symbol vectors for all symbols of the at least one constellation. This fifth function 44 is the core element of the receiver method 4.

In order to obtain a closed-form fifth function 44 providing s and penalty parameter λ by changing the first optimization formulation given as a sixth function 38, which is a real-valued quadratically constrained quadratic program (QCQP) version of a seventh function 6, which is recalculated into a generalized eigenvalue formulation and the Maus transformed eighth function 43. If this is done applying an iterative procedure to find the optimal solution (s^{opt}) for the estimation of transmitting symbols is performed. This is illustrated in step 406 of FIG. 11.

Furthermore in order to obtain the estimate solution of the methods 3 and 4 are calculated if the iterative procedure the coefficients β's, which are given in terms on the estimate solution s (s), the constellation alphabet (x), and the tightening parameter α are determined.

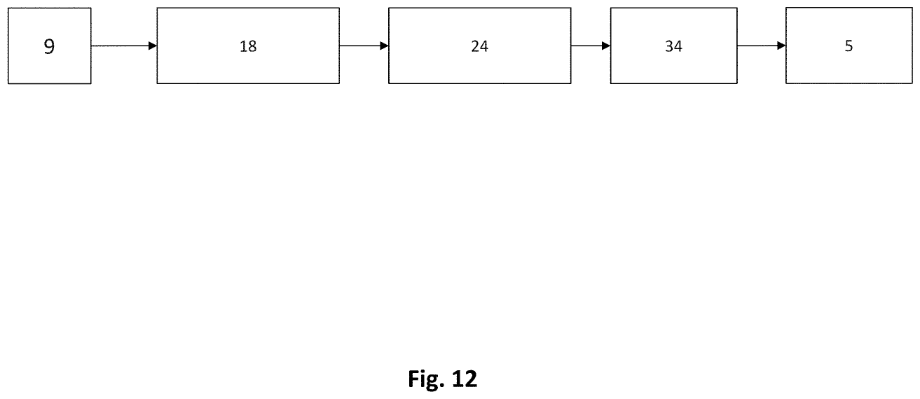

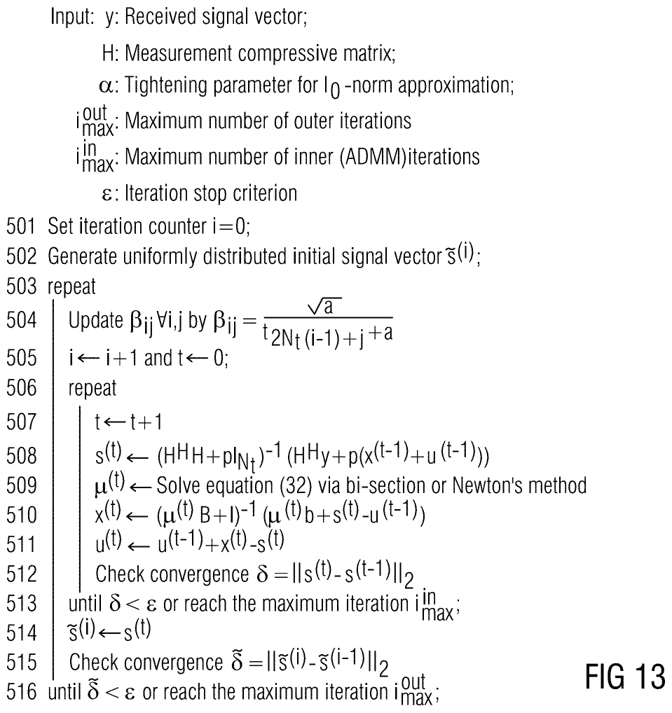

FIGS. 12 and 13 are illustrating the third embodiment of the of a computer-implemented receiver method 5.

FIGS. 12 and 13 are illustrating the third embodiment of the computer-implemented receiver method 5 of estimating transmit symbol vectors transmitted in an overloaded communication channel. The channel is characterized by a channel matrix of complex coefficients.

This third the method 5 includes the received signal vector corresponding to a superposition of signals representing transmitted symbols selected from at least one constellation of symbols and transmitted from one or more transmitters T. Furthermore a defining 104 of a search space in a convex domain including is done by defining 104 a search space in a convex domain including at least closed-form solution providing s and penalty parameter λ covering fifth function 44 of the received signal vector and of transmit symbol vectors for all symbols of the at least one constellation. This fifth function 34 is the core element of the receiver method 5.

The non closed-form ninth function (34) providing s and penalty parameter λ is obtained by changing the third optimization formulation given as a combination of a tenth function (9) and eleventh function (5), wherein the tenth function (9) is combined with the eleventh function (5) via a Quadratic Transform in order to obtain a twelfth function (18), wherein thirteenth function (24) is determined with a QCQP-1 transformation of the twelfth function (18) and Alternating Direction Method of Multipliers (ADMM) is applied the iterative procedure to find the optimal solution (s^{opt}) for the estimation of transmitting symbols is performed.

Furthermore in order to obtain the estimated solution of the method 5 is calculated if the iterative procedure the coefficients 13 as, which are determined by equation 20, with the loops and which have a special convergence criteria's to solve ninth function (34), which are given in terms on the estimate solution s (s), the constellation alphabet (x), and the tightening parameter α are determined.

This means, that the computer-implemented receiver method 5 of estimating transmit symbol vectors transmitted in an overloaded communication channel that is characterized by a channel matrix of complex coefficients, the method including, receiving 102, in a receiver R, a signal represented by a received signal vector, the received signal vector corresponding to a superposition of signals representing transmitted symbols selected from at least one constellation of symbols and transmitted from one or more transmitters T, defining 104 a search space in a convex domain including at least closed-form solution providing s and penalty parameter λ fifth function 44 of the received signal vector and of transmit symbol vectors for all symbols of the at least one constellation, obtaining a non closed-form ninth function 34 providing s and penalty parameter λ by changing the third optimization formulation given as a combination of a tenth function 9 and eleventh function 5, wherein the tenth function 9 is combined with the eleventh function 5 via a Quadratic Transform in order to obtain a twelfth function 18, wherein thirteenth function 24 is determined with a QCQP-1 transformation of the twelfth function 18 and Alternating Direction Method of Multipliers (ADMM) is applied and applying an iterative procedure to find the optimal solution (s^{opt}) for the estimation of transmitting symbols is performed.

Table I the relative performance of the first three proposed receivers in terms of their computational complexities are shown. For reference, it is included in that table the complexity of the SOAV and as well as the SBR decoders, while omitting that of SCSR since SOAV is the one that has lower cost, and since the BER performance of both is identical. The complexity performance assessment is carried out by counting the elapsed time of all compared receivers running 64-bit MATLAB 2018b in a computer with an Intel Core i9 processor, clock speed of 3.6 GHz and 32 GB of RAM memory. The results so obtained and summarized in Table I, elucidate that the complexity of the DAPZF receiver is not only the smallest amongst the three new methods, but in fact significantly lower (by a factor of almost l₀) than that of the SOAV decoder. And since DAPZF achieves similar BER performance as the ADMM-DAPSD and the DAGED methods in underloaded and fully loaded scenarios, it can be concluded that that scheme is the method of choice in those cases.

Table I also reveals that after DAPZF, DAGED is the second least computationally demanding of the new receivers, which when taken together with its BER performance, leads to the conclusion that the DAGED scheme is the trade-off method of choice amongst the three receivers here developed. Finally, the ADMM-DAPSD solution is found according to Table I to be the most computationally demanding of the all, which is non-surprising since this approach is also the one that yields the best BER performance in overloaded scenarios. All in all, the contributed methods therefore demonstrate feasibility of concurrently overloaded multidimensional systems, while offering three different choices according to the system setup.

TABLE I
RUNTIME COMPARISON OF PROPOSED
RECEIVER METHODS 1-3 AND State of the Art

| | | | Receiver | SOAV | SBR |
|---|---|---|---|---|---|
| | Receiver | Receiver | Method 3 | State | State |
| | Method 1 | Method 2 | (ADMM- | of the | of the |
| | (DAGED) | (DAFZF) | DAPSD) | Art | Art |
| Average | 0.2663 | 0.0034 | 0.5207 | 0.0166 | 0.2040 |
| Runtime | sec | sec | sec | sec | sec |
| E_{b}/N₀ 0 | | | | | |
| 14 [dB] | | | | | |
| (N_{T} = 60 & | | | | | |
| N_{R} = 40) | | | | | |

1. A computer-implemented receiver method of estimating transmit symbol vectors transmitted in an overloaded communication channel that is characterized by a channel matrix of complex coefficients, the method including:
receiving, in a receiver, a signal represented by a received signal vector, the received signal vector corresponding to a superposition of signals representing transmitted symbols selected from at least one constellation of symbols and transmitted from one or more transmitters,
defining a search space in a convex domain including at least a differentiable and convex function in a closed form of the received signal vector and of transmit symbol vectors for all symbols of the at least one constellation,
obtaining the differentiable and convex function in a closed form by changing the first optimization formulation given by a first function into a second optimization formulation given as a second function by applying a quadratic approximation of lₒ-Norm given as third function and after obtaining the second function a fourth function is calculated, and
applying an iterative procedure to find the optimal solution for the estimation of transmitting symbols is performed.

2. The method of claim 1, wherein differentiable and convex function in a closed form of the received signal vector and of transmit symbol vectors is obtained by applying the setting of the Wingerts derivative of the fourth function.

3. The method of claim 1, wherein the optimal solution calculated via a matrix multiplication for the fixed elements of the second function.

4. A computer-implemented receiver method of estimating transmit symbol vectors transmitted in an overloaded communication channel that is characterized by a channel matrix of complex coefficients, the method including:
receiving, in a receiver, a signal represented by a received signal vector, the received signal vector corresponding to a superposition of signals representing transmitted symbols selected from at least one constellation of symbols and transmitted from one or more transmitters,
defining a search space in a convex domain including at least closed-form solution providing s and penalty parameter λ fifth function of the received signal vector and of transmit symbol vectors for all symbols of the at least one constellation,
obtaining a closed-form fifth function providing s and penalty parameter λ by changing the first optimization formulation given as a sixth function, which is a real-valued quadratically constrained quadratic program version of a seventh function, which is recalculated into a generalized eigenvalue formulation and the Möbus transformed function,
applying an iterative procedure to find the optimal solution for the estimation of transmitting symbols is performed.

5. The method of claim 1, wherein within the iterative procedure the coefficients β's, which are given in terms on the estimate solution s, the constellation alphabet, and the tightening parameter α are determined.

6. The method of claim 1, wherein an incrementation of the iteration number i of the iterative procedure is proceeded.

7. The method of claim 1, wherein the calculation of solution variation d using the Euclidian distance between the solution of the current and previous iteration is proceeded.

8. The method of claim 1, wherein the convergence criteria is controlled in a way, if d<e or the maximum number of iterations has been reached, the iteration is terminated and the solution of the solution of the estimated transmitted vector s is determined and created.

9. A receiver of a communication system having a processor, volatile and/or non-volatile memory, at least one interface adapted to receive a signal in a communication channel, wherein the non-volatile memory stores computer program instructions which, when executed by the microprocessor, configure the receiver to estimate transmit symbol vectors transmitted in an overloaded communication channel that is characterized by a channel matrix of complex coefficients operations by performing operations comprising:
receiving in a receiver, a signal represented by a received signal vector, the received signal vector corresponding to a superposition of signals representing transmitted symbols selected from at least one constellation of symbols and transmitted from one or more transmitters,
defining a search space in a convex domain including at least a differentiable and convex function in a closed form of the received signal vector and of transmit symbol vectors for all symbols of the at least one constellation,
obtaining the differentiable and convex function in a closed form by changing the first optimization formulation given by a first function into a second optimization formulation given as a second function by applying a quadratic approximation of lₒ-Norm given as third function and after obtaining the second function a fourth function is calculated; and
applying an iterative procedure to fin the optimal solution for the estimation of transmitting symbols is performed.

10. (canceled)

11. (canceled)

12. The receiver of claim 9, wherein differentiable and convex function in a closed form of the received signal vector and of transmit symbol vectors is obtained by applying the setting of the Wingerts derivative of the fourth function.

13. The receiver of claim 9, wherein the optimal solution calculated via a matrix multiplication for the fixed elements of the second function.

14. The receiver of claim 9, wherein an Incrementation of the iteration number i of the iterative procedure is proceeded.

15. The receiver of claim 9, wherein the calculation of solution variation d using the Euclidian distance between the solution of the current and previous iteration is proceeded.

16. The receiver of claim 9, wherein the convergence criteria is controlled in a way, if d<e or the maximum number of iterations has been reached, the iteration is terminated and the solution of the solution of the estimated transmitted vector s is determined and created.

17. A receiver configured for estimating transmit symbol vectors transmitted in an overloaded communication channel that is characterized by a channel matrix of complex coefficients, by performing operations including:
receiving, in a receiver, a signal represented by a received signal vector, the received signal vector corresponding to a superposition of signals representing transmitted symbols selected from at least one constellation of symbols and transmitted from one or more transmitters,
defining a search space in a convex domain including at least closed-form solution providing s and penalty parameter λ fifth function of the received signal vector and of transmit symbol vectors for all symbols of the at least one constellation,
obtaining a closed-form fifth function providing s and penalty parameter λ by changing the first optimization formulation given as a sixth function, which is a real-valued quadratically constrained quadratic program version of a seventh function, which is recalculated into a generalized eigenvalue formulation and the Möbus transformed eighth function, and
applying an iterative procedure to find the optimal solution for the estimation of transmitting symbols is performed.

18. The receiver of claim 17, wherein within the iterative procedure the coefficients β's, which are given in terms on the estimate solution s, the constellation alphabet, and the tightening parameter α are determined.

19. The receiver of claim 17, wherein the optimal solution calculated via a matrix multiplication for the fixed elements of the second function.

20. The receiver of claim 17, wherein a Incrementation of the iteration number i of the iterative procedure is proceeded.

21. The receiver of claim 17, wherein the calculation of solution variation d using the Euclidian distance between the solution of the current and previous iteration is proceeded.

22. The receiver of claim 17, wherein the convergence criteria is controlled in a way, if d<e or the maximum number of iterations has been reached, the iteration is terminated and the solution of the solution of the estimated transmitted vector s is determined and created.
